(19) United States
(12) Patent Application Publication
(10) Pub. No.: US 2023/0258334 A1
(43) Pub. Date: Aug. 17, 2023

(54) Non-Complex, Naturally Aspirated, Increased Efficiency, Reduced Smoke, Reduced Creosote Combustion Chamber Utilizing Wood, Wood Products, and/or other solid Organic Materials as Fuel.

(71) Applicant: THOMAS CARLIN WEBB, SPRINGFIELD, MO (US)

(72) Inventor: THOMAS CARLIN WEBB, SPRINGFIELD, MO (US)

(21) Appl. No.: 17/672,580

(22) Filed: Feb. 15, 2022

(51) Int. Cl. F23L 9/02; F23L 7/00

(52) U.S. Cl. CPC F23L 9/02; F23L 7/007

(57) ABSTRACT

This invention is a non-complex naturally aspirated, increased efficiency, reduced smoke, reduced creosote combustion chamber used in wood stoves and furnaces utilizing wood, wood products, and/or other solid organic materials as fuel. The combustion chamber design provides a flow of fresh naturally aspirated oxygen-rich air into the area above the burning fuel in order to more completely burn the volatized, combustible compounds released from the burning fuel before burning the non-volatile combustible compounds within the fuel. As a result, the combustion process is more complete and efficient, and reduces the amount of creosote and smoke emitted from the combustion chamber into the exhaust outlet/chimney.

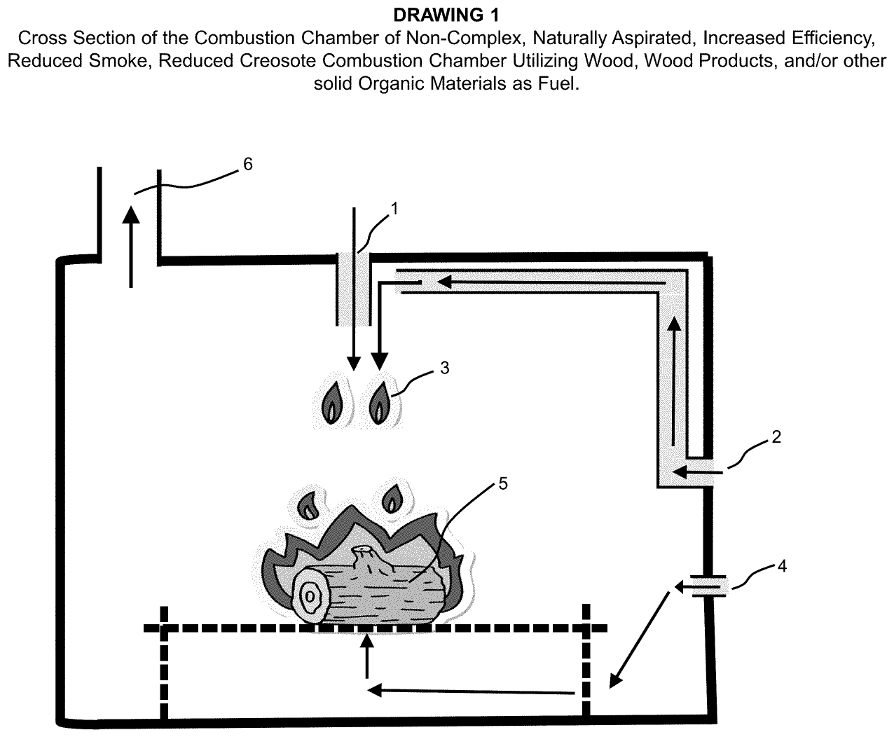

### CROSS-REFERENCE TO RELATED APPLICATIONS

This application is a non-provisional application of provisional patent application No. 63/177,363, filed on Apr. 20, 2021, and priority is claimed thereto.

### STATEMENT REGARDING FEDERALLY SPONSORED RESEARCH OR DEVELOPMENT

Not Applicable

### BACKGROUND OF THE INVENTION

This device relates to combustion chambers used in stoves and furnaces burning wood, wood products and other organic materials.

For hundreds of years naturally aspirated non-complex combustion chambers in wood stoves and furnaces have allowed fresh oxygen-containing air to enter the combustion chamber through restricted, adjustable opening(s) on the front (most common), back, bottom, and/or sides of the combustion chamber. Most of the cooler denser oxygen-rich fresh air drops to the bottom of the combustion chamber and then moves under and up into the hot burning fuel, causing some of the volatile and non-volatile compounds in the fuel to burn.

Since the amount of fresh oxygen-containing air is restricted to control the burning rate of the fuel, a substantial quantity of volatile compounds in the fuel evaporate and flow upward from the fuel, but do not burn due to insufficient oxygen above the fuel. The unburned volatile compounds are expelled into the exhaust outlet/chimney. When cooled, they condense to form smoke and creosote.

Existing higher efficiency wood burning combustion chambers incorporate designs that are more complex and expensive to manufacture, such as combustion chambers that utilize fresh air downdrafts into the fuel, or use secondary combustion chambers, or forced air to burn the volatized fuel compounds.

### BRIEF SUMMARY OF THE INVENTION

This invention is a non-complex naturally aspirated, increased efficiency, reduced smoke, reduced creosote combustion chamber utilizing wood, wood products, and/or other solid organic materials as fuel. The combustion chamber design provides a flow of fresh oxygen-rich air into the area above the burning fuel in order to more completely burn the volatized, combustible compounds released from the burning fuel before burning the non-volatile combustible compounds within the fuel. As a result, the combustion process is more complete and efficient, and reduces the amount of creosote and smoke emitted from the combustion chamber into the exhaust outlet/chimney 6.

### BRIEF DESCRIPTION OF THE VIEW OF THE DRAWING

Drawing #1 is cross section of an increased efficiency, reduced smoke, reduced creosote combustion chamber for burning wood products, and other organic materials depicting how and where the fresh air is directed into the area of the combustion chamber above the burning fuel that contains the hot unburned volatilized combustible compounds.

### DETAILED DESCRIPTION OF THE INVENTION

Fresh air enters the area above the level of the burning fuel through opening(s) above the combustion area 1 and/or pipe(s), tube(s), channel(s), baffle(s) and/or other types of air funneling devices from the front, back, bottom, side(s) or top surface(s) of the combustion chamber 2.

This provides a flow of fresh oxygen-rich air into the area above the burning fuel 3 in order to more completely burn the volatized, combustible compounds released and rising from the burning fuel before burning the non-volatile combustible compounds within the fuel.

The combustion chamber may also contain fixed or adjustable fresh air entry intake portal(s) to introduce additional fresh air below the fuel for starting the fire and for adjusting the burn rate of the volatile and non-volatile fuel compounds 4.

A commonly available off-the-shelf access door is located in one of the combustion chamber's wall for adding fuel and removing ashes from the combustion chamber, as are universally built into existing designs of wood stoves and furnaces. (Not depicted in the drawing.)

Commonly available off-the shelf adjustable fresh air restriction devices, backflow-prevention devices, and flame suppressors may be used to control the flow rate of fresh air into the combustion chamber and prevent heated gasses and flames from escaping through the fresh air entry points, as are commonly built into existing designs of wood stoves and furnaces. (Not depicted in the drawing.)

1. When fresh oxygen-rich air is introduced into a combustion chamber above the level of the burning fuel (wood, wood products, and other organic materials, the hot volatized fuel compounds released from the burning fuel mix with the fresh oxygen-rich air above the fuel and thus burn more completely 3. The remaining the solid non-volatile compounds within the fuel 5 are more oxygen starved and thus burn at a slower rate and at a lower temperature, reducing the evaporation rate of the volatile compounds from the fuel so that they burn more completely when mixed with fresh oxygen-rich air above the fuel 3.

2. The combustion process is self-regulating. After most of the volatized combustible compounds from the fuel are burned, more oxygen is available to circulate within the combustion chamber to support a faster burn rate of the remaining solid non-volatile compounds within the fuel.

3. Fixed or adjustable fresh air entry intake portal(s) 4 introduce additional fresh oxygen-rich air below the fuel for starting the fire and for adjusting the burn rate ratio of the volatile and non-volatile fuel compounds.
